(19) United States
(12) Patent Application Publication
(10) Pub. No.: US 2024/0065920 A1
(43) Pub. Date: Feb. 29, 2024

(54) WALKING ASSISTANCE DEVICE

(71) Applicant: TOYOTA JIDOSHA KABUSHIKI KAISHA, Toyota-shi (JP)

(72) Inventors: Takumi MATSUO, Ichikawa-shi (JP); Jiro GOTO, Seto-shi (JP); Tomoe AOKI, Chiba-shi (JP)

(73) Assignee: TOYOTA JIDOSHA KABUSHIKI KAISHA, Toyota-shi, Aichi-ken (JP)

(21) Appl. No.: 18/216,303

(22) Filed: Jun. 29, 2023

(30) Foreign Application Priority Data
Aug. 29, 2022 (JP) 2022-135538

(51) Int. Cl. A61H 3/00

(52) U.S. Cl. CPC A61H 3/00; A61H 2003/007; A61H 2201/163; A61H 2201/1642

(57) ABSTRACT

A walking assistance device includes: a waist attachment portion attached to a waist; a right knee attachment portion attached to a right knee; a left knee attachment portion attached to a left knee; and a wire that extends from the right knee attachment portion along a front surface of a right thigh, passes through the waist attachment portion, and extends along a front surface of a left thigh to reach the left knee attachment portion. The wire assists a motion of swinging the left thigh forward when the right thigh is kicked backward, and assists a motion of swinging the right thigh forward when the left thigh is kicked backward.

### CROSS-REFERENCE TO RELATED APPLICATION

This application claims priority to Japanese Patent Application No. 2022-135538 filed on Aug. 29, 2022, incorporated herein by reference in its entirety.

### BACKGROUND

### 1. Technical Field

The present disclosure relates to a walking assistance device.

### 2. DESCRIPTION OF RELATED ART

Japanese Patent No. 6889187 (JP 6889187 B) discloses a technique for assisting a motion of swinging a thigh forward by connecting a waist belt and a thigh brace with a flexible strap.

### SUMMARY

However, in the configuration of JP 6889187 B, an assisting force that assists a motion of swinging a thigh forward is weak.

An object of the present disclosure is to provide a technique that sufficiently secures an assisting force that assists a motion of swinging a thigh forward with a simple configuration.

According to an aspect of the present disclosure, provided is a walking assist device including: a waist attachment portion attached to a waist; a right knee attachment portion attached to a right knee; a left knee attachment portion attached to a left knee; and a wire that extends from the right knee attachment portion along a front surface of a right thigh, passes through the waist attachment portion, and extends along a front surface of a left thigh to reach the left knee attachment portion, in which the wire assists a motion of swinging the left thigh forward when the right thigh is kicked backward, and assists a motion of swinging the right thigh forward when the left thigh is kicked backward. According to the above configuration, it is possible to sufficiently ensure the assisting force that assists the motion of swinging the thigh forward with a simple configuration.

The waist attachment portion may include a wire guide extending along an outer periphery of the waist, and the wire may extend from the right knee attachment portion to the wire guide, be guided by the wire guide to extend along a longitudinal direction of the wire guide, and reach the left knee attachment portion. According to the above configuration, a configuration in which the wire extends from the right knee attachment portion to the wire guide, is guided by the wire guide to extend along a longitudinal direction of the wire guide, and reaches the left knee attachment portion is achieved.

The wire guide may include a guide back surface portion arranged on a back surface side of the waist, and the wire may extend from the right knee attachment portion to reach the wire guide, pass through the guide back surface portion of the wire guide, and reach the left knee attachment portion. According to the above configuration, the total length of the wire can be gained.

The wire guide may include a guide back surface portion arranged on a back surface side of the waist, and a pair of guide front surface portions arranged on a front surface side of the waist and adjacent to each other along a longitudinal direction of the waist attachment portion, the guide front surface portions may be swingably attached to the guide back surface portion, and the guide front surface portions may be detachable from each other. According to the above configuration, by temporarily releasing the mutual connection between the pair of front surface portions, the wire guide can be easily attached to the waist. A full length adjusting tool that adjusts a full length of the wire by winding a part of the wire may be provided. According to the above configuration, the total length of the wire can be adjusted.

According to the present disclosure, with a simple configuration, it is possible to sufficiently secure an assisting force that assists a motion of swinging a thigh forward.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a front view of a walking assistance device;

FIG. 2 is a plan view of a waist attachment portion;

FIG. 3 is a plan view of the waist attachment portion;

FIG. 4 is an explanatory diagram of an operating mechanism of the walking assistance device.

### DETAILED DESCRIPTION OF EMBODIMENTS

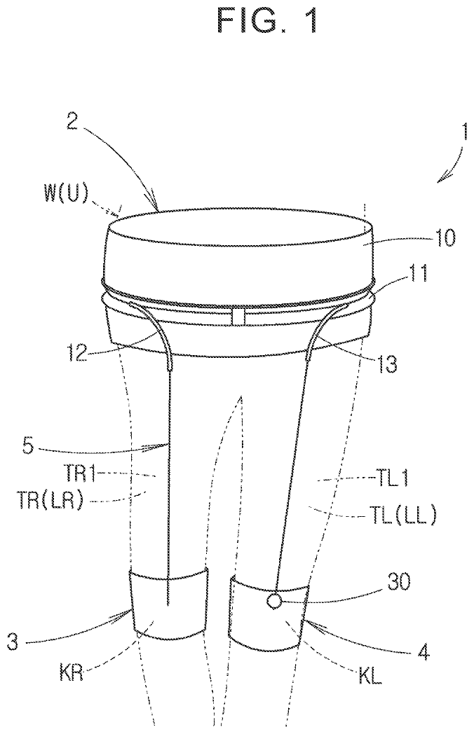

A preferred embodiment of the present disclosure will be described with reference to FIGS. 1 to 4.

FIG. 1 shows a walking assistance device 1. The walking assistance device 1 is typically a device that assists swinging a thigh forward during walking. In addition, the walking assistance device 1 can assist the motion of swinging the thigh forward during running.

As shown in FIG. 1, the walking assistance device 1 includes a waist attachment portion 2, a right knee attachment portion 3, a left knee attachment portion 4, and a wire 5.

The waist attachment portion 2 is configured to be worn on a waist W of a user U.

The right knee attachment portion 3 is configured to be attached to the user's U right knee KR. The left knee attachment portion 4 is configured to be attached to the user's U left knee KL. The wire 5 extends from the right knee attachment portion 3 along a front surface TR1 of a right thigh TR, passes through the waist attachment portion 2, and extends along a front surface TL1 of a left thigh TL to reach the left knee attachment portion 4. With this configuration, the wire 5 assists a motion of swinging the left thigh TL forward when the right thigh TR is kicked backward, and assists a motion of swinging the right thigh TR forward when the left thigh TL is kicked backward.

The waist attachment portion 2, the right knee attachment portion 3, the left knee attachment portion 4, and the wire 5 will be described in detail below.

The wire 5 is made of a material that is difficult to stretch. The non-stretchable material can typically be made by weaving a plurality of raw threads of ultrafine polyethylene material.

The right knee attachment portion 3 is attachable to and detachable from the right knee KR so as not to interfere with the bending and stretching motion of the right knee KR. The right knee attachment portion 3 is typically made of cloth. The right knee attachment portion 3 is provided with, for example, a hook-and-loop fastener so that it can be easily attached to and detached from the right knee KR.

Similarly, the left knee attachment portion 4 is attachable to and detachable from the left knee KL so as not to interfere with the bending and stretching motion of the left knee KL. The left knee attachment portion 4 is typically made of cloth. The left knee attachment portion 4 can be easily attached to and detached from the left knee KL by being provided with, for example, a hook-and-loop fastener.

The waist attachment portion 2 includes a winding portion 10 that is wrapped around the waist W, a wire guide 11 that extends along the waist W, a right bending guide 12, and a left bending guide 13.

The winding portion 10 is typically made of cloth. The winding portion 10 can be easily attached to and detached from the waist W by being providing with a hook-and-loop fastener, for example.

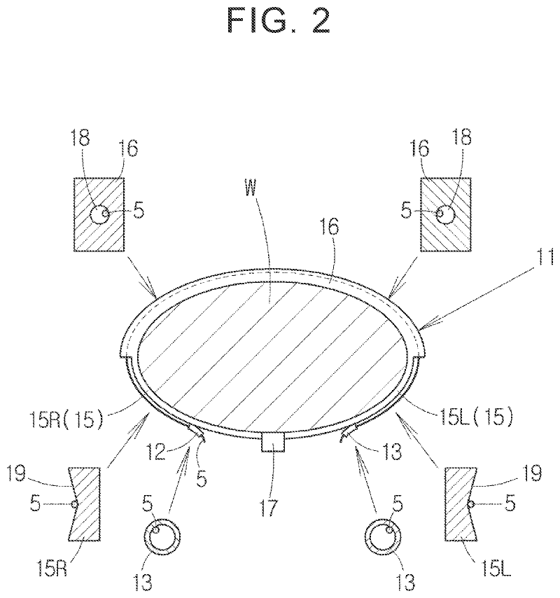

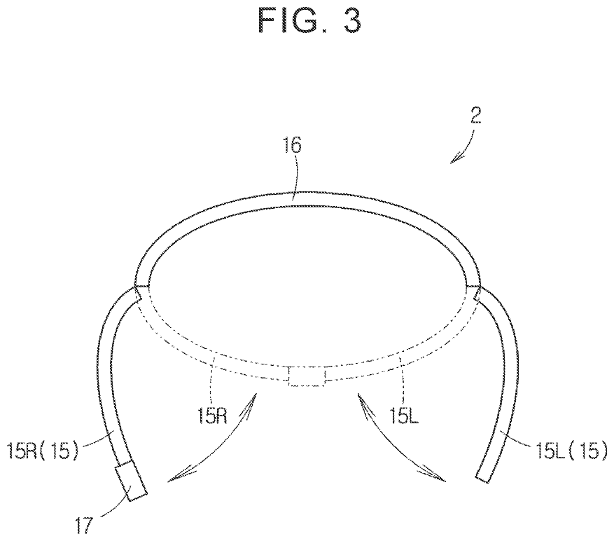

The wire guide 11 is supported by the winding portion 10 and has an annular shape in plan view. As shown in FIG. 2, the wire guide 11 includes a guide front surface portion 15 arranged on the front surface side of the waist W and a guide back surface portion 16 arranged on the back surface side of the waist W. The guide front surface portion includes a right guide front surface portion 15R on the right leg side and a left guide front surface portion 15L on the left leg side. As shown in FIG. 3, the right guide front surface portion 15R and the left guide front surface portion 15L are detachable from and attachable to each other via a connector 17 fixed to the right guide front surface portion 15R. The right guide front surface portion 15R is connected to the guide back surface portion 16 so as to be swingable. The left guide front surface portion 15L is connected to the guide back surface portion 16 so as to be swingable. The wire guide 11 is typically made of stainless steel or aluminum alloy.

Returning to FIG. 2, the guide back surface portion 16 includes a guide hole 18 through which the wire 5 passes. The guide hole 18 is formed so as to extend along a longitudinal direction of the guide back surface portion 16.

A guide groove 19 having a V-shaped cross section and opening in a direction away from the waist W is formed in the guide front surface portion 15. The guide groove 19 has a V-shaped cross section that opens outward.

Returning to FIG. 1, the right bending guide 12 and the left bending guide 13 guide the wire 5. The right bending guide 12 bends the wire 5 extending upward from the right knee attachment portion 3 and guides the wire 5 to the wire guide 11. The left bending guide 13 bends the wire 5 extending upward from the left knee attachment portion 4 and guides the wire 5 to the wire guide 11. The right bending guide 12 and the left bending guide 13 are arranged on the front surface side of the waist W.

In this embodiment, the right bending guide 12 is a metal pipe, typically an aluminum alloy pipe, that curves in an arc, and is supported by the wire guide 11. The wire 5 extending along the front surface TR1 of the right thigh TR of the right leg LR is smoothly curved by passing through the right bending guide 12 and guided to the guide groove 19 of the right guide front surface portion 15R of the wire guide 11.

Similarly, the left bending guide 13 is a metal pipe, typically an aluminum alloy pipe, that curves in an arc shape, and is supported by the wire guide 11. The wire 5 extending along the front surface TL1 of the left thigh TL of the left leg LL is smoothly curved by passing through the left bending guide 13 and guided to the guide groove 19 of the left guide front surface portion 15L of the wire guide 11.

The right bending guide 12 and the left bending guide 13 may be, for example, pulleys instead of being pipes curved in an arc.

With the above configuration, as shown in FIGS. 1 and 2, one end of the wire 5 is fixed to the right knee attachment portion 3, starts from the right knee attachment portion 3, extends along the front surface TR1 of the right thigh TR of the right leg LR, and passes through the right bending guide 12 to be guided to the right guide front surface portion 15R of the wire guide 11. The wire 5 passes through the guide groove 19 of the right guide front surface portion 15R and the guide hole 18 of the guide back surface portion 16 in this order, and reaches the guide groove 19 of the left guide front surface portion 15L. The wire 5 further passes through the left bending guide 13, and extends along the front surface TL1 of the left thigh TL of the left leg LL to reach the left knee attachment portion 4. The other end of the wire 5 is fixed to the left knee attachment portion 4.

As shown in FIG. 1, the left knee attachment portion 4 is provided with a full length adjustment tool 30 that adjusts the full length of the wire 5 by winding a part of the wire 5. Instead of being provided on the left knee attachment portion 4, the full length adjustment tool 30 may be provided on the right knee attachment portion 3, may be provided on the wire 5 between the right knee attachment portion 3 and the waist attachment portion 2, or may be provided on the wire 5 between the left knee attachment portion 4 and the waist attachment portion 2. As the full length adjustment tool 30, a BOA Fit System (registered trademark) can typically be adopted.

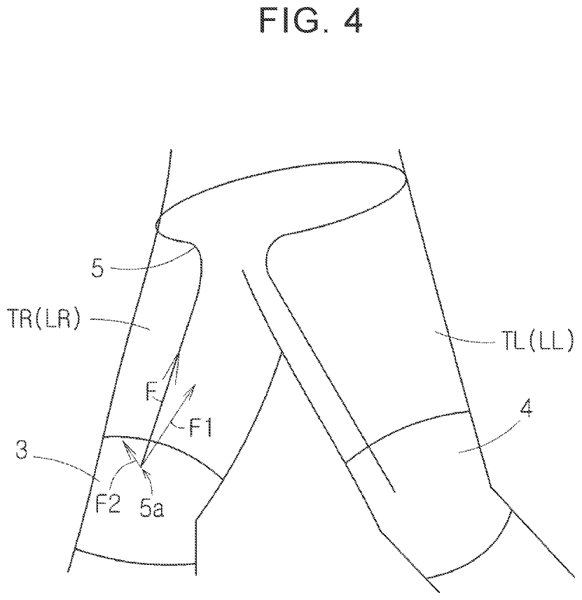

FIG. 4 shows how the walking assistance device 1 assists the movement of swinging the right thigh TR and the left thigh TL forward alternately. As shown in FIG. 4, when the left leg LL is kicked backward in a stance phase of the left leg LL, the wire 5 is pulled out from the waist attachment portion 2 to the left leg LL side and the wire 5 is pulled in toward the waist attachment portion 2 on the right leg LR side. At this time, a tension F generated in the wire 5 on the right leg LR side consists of a component force F1 directed from an end portion 5a of the wire 5 on the right knee attachment portion 3 side to a right hip joint, and a component force F2 directed forward from the end portion 5a (in the direction in which the right thigh TR that is a free leg swings out). This component force F2 assists the motion of swinging the right thigh TR forward during the swing phase of the right leg LR.

In contrast, when the right leg LR is kicked backward during the stance phase of the right leg LR, the wire 5 is pulled out from the waist attachment portion 2 to the right leg LR side. Thus, the wire 5 is drawn towards the waist attachment portion 2 on the left leg LL side. At this time, the component force of the tension F generated in the wire 5 on the left leg LL side assists the motion of swinging the left thigh TL forward during the swing phase of the left leg LL.

The preferred embodiments of the present disclosure have been described above. The above-described embodiment has the following features.

As shown in FIGS. 1 to 4, the walking assistance device 1 includes the waist attachment portion 2 attached to the waist W, the right knee attachment portion 3 attached to the right knee KR, the left knee attachment portion 4 attached to the left knee KL, and the wire 5 that extends from the right knee attachment portion 3 along the front surface TR1 of the right thigh TR, passes through the waist attachment portion 2, and extends along the front surface TL1 of the left thigh TL to reach the left knee attachment portion 4. The wire 5 assists a motion of swinging the left thigh TL forward when the right thigh TR is kicked backward, and assists a motion of swinging the right thigh TR forward when the left thigh TL is kicked backward. According to the above configuration, it is possible to sufficiently ensure the assisting force that assists the motion of swinging the thigh forward with a simple configuration.

Further, the waist attachment portion 2 includes the wire guide 11 extending along an outer periphery of the waist W. The wire 5 may extend from the right knee attachment portion 3 to the wire guide 11, be guided by the wire guide 11 to extend along a longitudinal direction of the wire guide 11, and reach the left knee attachment portion 4. According to the above configuration, a configuration in which the wire 5 extends from the right knee attachment portion 3 to the wire guide 11, is guided by the wire guide 11 to extend along the longitudinal direction of the wire guide 11, and reaches the left knee attachment portion 4 is achieved.

The wire guide 11 also includes the guide back surface portion 16 that is arranged on the back surface side of the waist W. The wire 5 extends from the right knee attachment portion 3 to reach the wire guide 11, pass through the guide back surface portion 16 of the wire guide 11, and reach the left knee attachment portion 4. According to the above configuration, the total length of the wire 5 can be gained.

In addition, the wire guide 11 includes the guide back surface portion 16 arranged on the back surface side of the waist W, and the right guide front surface portion 15R and the left guide front surface portion 15L serving as the pair of guide front surface portions arranged on the front surface side of the waist W and adjacent to each other along the longitudinal direction of the waist attachment portion 2. The right guide front surface portion 15R and the left guide front surface portion 15L are attached to the guide back surface portion 16 so as to be swingable. The right guide front surface portion 15R and the left guide front surface portion 15L are detachable from each other. According to the above configuration, the wire guide 11 can be easily attached to the waist W by temporarily releasing the mutual connection between the right guide front surface portion 15R and the left guide front surface portion 15L.

Moreover, the walking assistance device 1 further includes the full length adjustment tool 30 that adjusts the full length of the wire 5 by winding a part of the wire 5. According to the above configuration, the total length of the wire 5 can be adjusted. Therefore, since the full length of the wire 5 can be adjusted according to the length of the thigh of the user U, efficient assistance by the walking assistance device 1 can be realized.

The wire 5 is slidable with respect to the right bending guide 12. The wire 5 is slidable in the guide groove 19 of the guide front surface portion 15. The wire 5 is slidable in the guide hole 18 of the guide back surface portion 16.

What is claimed is:

1. A walking assistance device comprising:
a waist attachment portion attached to a waist;
a right knee attachment portion attached to a right knee;
a left knee attachment portion attached to a left knee; and
a wire that extends from the right knee attachment portion along a front surface of a right thigh, passes through the waist attachment portion, and extends along a front surface of a left thigh to reach the left knee attachment portion,
wherein the wire assists a motion of swinging the left thigh forward when the right thigh is kicked backward, and assists a motion of swinging the right thigh forward when the left thigh is kicked backward.

2. The walking assistance device according to claim 1,
wherein the waist attachment portion includes a wire guide extending along an outer periphery of the waist, and
wherein the wire extends from the right knee attachment portion to the wire guide, is guided by the wire guide to extend along a longitudinal direction of the wire guide, and reaches the left knee attachment portion.

3. The walking assistance device according to claim 2,
wherein the wire guide includes a guide back surface portion arranged on a back surface side of the waist, and
wherein the wire extends from the right knee attachment portion to reach the wire guide, passes through the guide back surface portion of the wire guide, and reaches the left knee attachment portion.

4. The walking assistance device according to claim 2,
wherein the wire guide includes a guide back surface portion arranged on a back surface side of the waist, and a pair of guide front surface portions arranged on a front surface side of the waist and adjacent to each other along a longitudinal direction of the waist attachment portion, and
wherein the guide front surface portions are swingably attached to the guide back surface portion, and
wherein the guide front surface portions are detachable from each other.

5. The walking assistance device according to claim 3, further comprising a full length adjusting tool that adjusts a full length of the wire by winding a part of the wire.
